(19) United States
(12) Patent Application Publication
(10) Pub. No.: US 2007/0011682 A1
(43) Pub. Date: Jan. 11, 2007

(54) Affinization of transaction types

(76) Inventors: Charles Zdzislaw Loboz, West Ryde (AU); Jonatan Kelu, Granville (AU); Paul Street, Westleigh (AU)

Correspondence Address: UNISYS CORPORATION, UNISYS WAY, MAILSTOP E8-114, BLUE BELL, PA, 19424-0001, US

(21) Appl. No.: 10/541,109

(22) PCT Filed: Jan. 2, 2003
(86) PCT No.: PCT/US03/00085

§ 371 Date: Jun. 30, 2005

(51) Int. Cl. G06F 9/46

(52) U.S. Cl. 718/104

(57) ABSTRACT

The present invention relates to a system and method for improving the efficiency of transaction processing systems by associating each one of plurality of transaction types with a respective central processing unit.

### FIELD OF THE INVENTION

The present invention relates to a system and method for improving the efficiency of transaction processing systems.

### BACKGROUND OF THE INVENTION

As the demand for computing resources has increased exponentially over the past decade, new ways have been sought to allow computing systems to process large amounts of data and user requests in an efficient manner.

A common way to handle a large number of simultaneous user requests on a single computing system is to divide the requests either by software or by hardware,, into separate “tasks” or “transactions”. In a software environment, this has become known as multi-tasking, a method whereby simultaneous user requests are placed in a queue, and executed in a sequential manner by a process.

A transaction request will be understood to be a request generated by a software application, for some task to be performed by a computing system. A process will be understood to be a component (usually software) within an operating system which accepts a transaction request (hereinafter referred to as a “transaction”), queues the transaction, and then processes the transaction.

It is known to improve the efficiency with which processor caches are utilised by creating an affinity between the application processes that execute the business logic, and the central processing units (CPUs) that contain the caches.

In the prior art, a particular application process may always interact with the same CPU. The creation of an affinity between an application process and a CPU ensures that whenever a particular application process executes, it always executes on the same CPU. This makes better use of a CPUs cache because, by always running a particular application process on the same CPU, there is a good chance that the CPU cache will contain the information relevant to the application process from a previous run.

On the other hand, if the application process was scheduled to a random CPU, it is likely that the CPU cache will not contain the information needed by the process to run, and this information will need to be loaded in from main memory, thus degrading application performance.

A solution such as the one outlined above is disclosed in patent application PCT/US02/07590, entitled “Improving Transaction Processing Performance by Preferentially Reusing Frequently Used Processes” filed on 14 Mar. 2002 at the US Patent and Trade Mark Office.

The shortcoming of the prior art is that each application process continues to receive a mix of different types of transactions from the transaction processing system. In practice, every application process performs not one, but a number of different types of transactions. The transactions that an application process performs depends largely on the types of transactions requested by the users of the system. As users request various transactions to be performed, the transactions are randomly sent to any of the available application processes for execution.

### SUMMARY OF THE INVENTION

In a first aspect, the present invention provides a method for processing a transaction in a transaction processing system, comprising the steps of, for a plurality of transaction types, associating each one of the plurality of transaction types with at least one central processing unit, and, on receipt of a transaction request from a client, determining the transaction request type, locating the associated central processing unit, and forwarding the transaction request to the associated central processing unit.

The invention provides a method whereby similar types of transactions preferably do use the same CPU. The method is preferably achieved by affinitizing at least one transaction type to a CPU or set of CPUs, thereby minimizing the chance that the machine instructions of one transaction type overwrite the machine instructions of another transaction type in the CPU cache.

In the present context, affinization will be understood to mean any methodology whereby similar types of transactions are preferably allocated to a single CPU. The affinitization process preferably increases CPU cache performance and therefore also increases transaction throughput, resulting in an improved response time.

This is advantageous because different types of transactions have their own unique business logic, and therefore their own unique sequence of machine instructions to execute. When, in the prior art, each application process (and by implication each CPU), executes a random selection of different types of transactions, there is a high probability that the machine instructions of a currently executing transaction type will overwrite the cached machine instructions of another transaction type that previously executed on the CPU.

When a transaction of a particular type executes on the CPU, the instructions relevant to the aforementioned transaction type are no longer in the cache, and these instructions need to be reloaded from main memory.

The present invention ameliorates this problem by affinitizing a transaction type with a CPU. As similar transaction “types” are always executed on the same CPU, the need to overwrite the CPU cache is minimised, and consequently, the time taken to execute a transaction is minimised.

Preferably, the method comprises the further step of measuring the resource usage of a particular transaction type and utilising the resource usage data to allocate the transaction type to a central processing unit.

Preferably, the resource usage data includes data indicative of the number of transactions of a particular type that are processed relative to other transaction types.

Preferably, the resource usage data includes data indicative of the amount of computing resources required to process a transaction.

In an embodiment of the present invention, there is provided a transaction processing system that can execute a plurality of transaction types. In the present context, a transaction will be understood to mean a request from a user and/or another computing system to perform a task. This task may include the computation of a mathematical value, the manipulation of data, and/or any other task conventionally performed by the CPU of a computing system. The aforementioned transaction types are given as examples only, and should be construed as illustrative but not limiting the present invention.

The computing system which runs the transaction processing system is comprised at least two CPU, but may comprise a multiple number of CPUs. One method employed by the applicant to ensure that the machine instructions of one transaction do not overwrite the machine instructions of another transaction in the CPU cache is to assign each transaction type to a particular CPU.

If there is a situation in which there are more available CPUs than transaction types, the extra CPUs can have the most CPU intensive transaction types affinitized to them so as not to waste CPU resources unnecessarily. Thus the most CPU intensive transaction types is may be affinitized to more than one CPU.

Where the computing system has more transaction types than CPUs, the most CPU intensive transaction types would be allocated at least one CPU exclusively, while the less CPU intensive transaction types share a CPU.

Preferably, at least one less intensive transaction type shares processing time on a CPU with at least one another less intensive transaction type.

In a second aspect, the present invention provides a system for processing a transaction in a transaction processing system, comprising, association means arranged to associate each one of a plurality of transaction types with at least one central processing unit, and allocation means arranged, on receipt of a transaction request from a client, to determine the transaction request type, locate the associated central processing unit, and forward the transaction request to the associated central processing unit.

In a third aspect, the present invention provides a method for affinitizing a transaction type to a central processing unit, the method comprising the steps of, for each transaction type, providing resource usage data indicative of the amount of computing resources required to process a transaction type, and using the resource usage data to associate each transaction type to at least one central processing unit.

In a fourth aspect, there is provided a computer program arranged, when loaded on a computing system, to implement the method of the first aspect of the invention, or any dependent claim thereof.

In a fifth aspect, there is provided a computer readable medium providing a computer program in accordance with a fourth aspect of the invention.

### DETAILED DESCRIPTION OF THE DRAWINGS

Features of the present invention will be presented in the description of an embodiment thereof, by way of example, with reference to the accompanying drawings, in which;

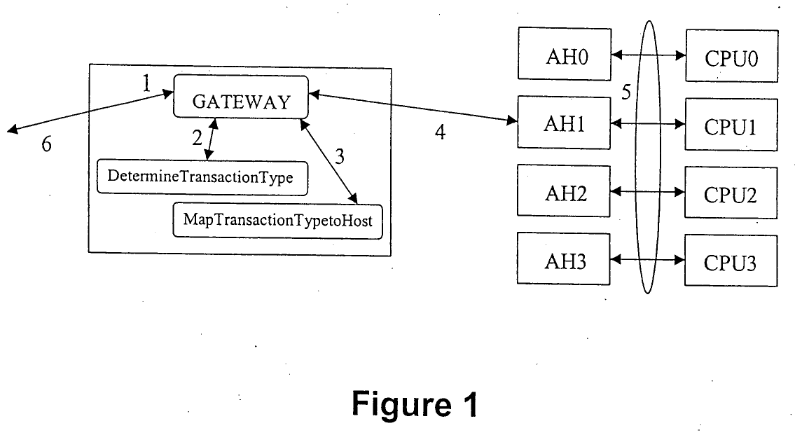

FIG. 1 is a flowchart outlining the steps necessary to manage a system in accordance with an embodiment of the invention;

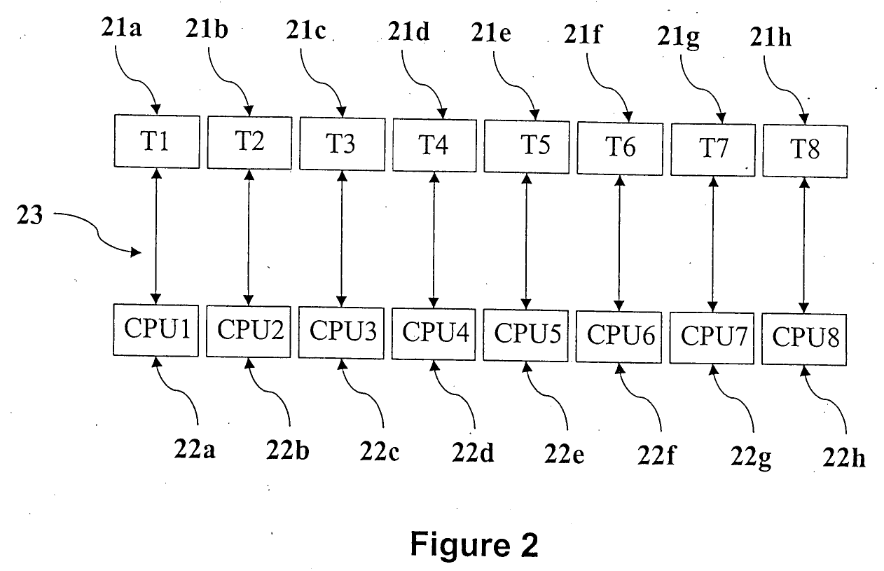

FIG. 2 is a schematic diagram illustrating the operation of an embodiment of the invention;

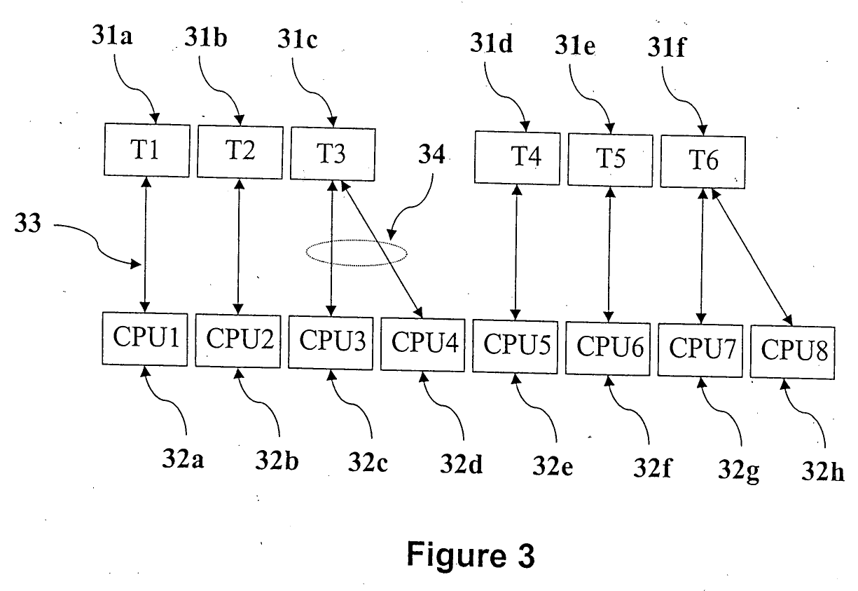

FIG. 3 is a schematic diagram illustrating the operation of an embodiment of the invention; and

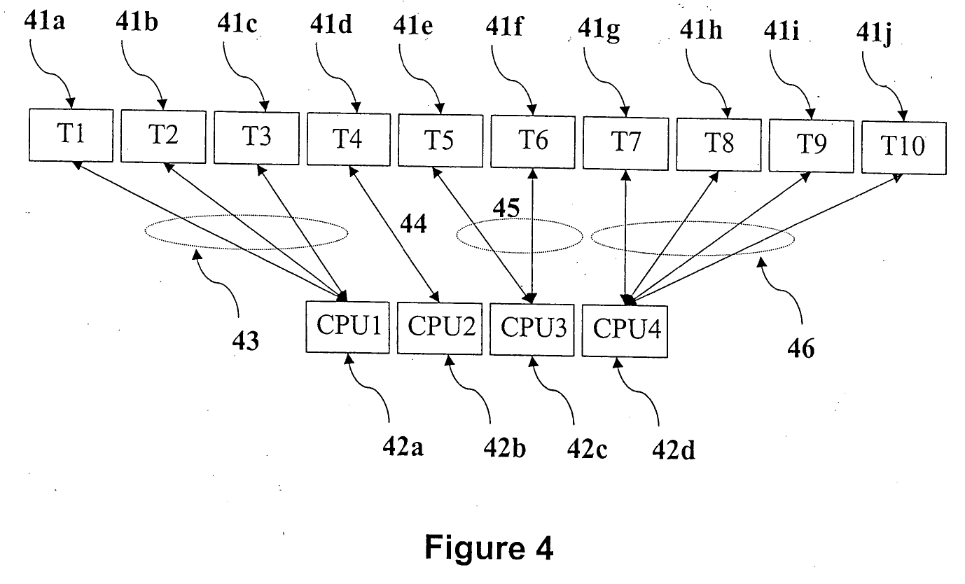

FIG. 4 is a schematic diagram illustrating the operation of an embodiment of the present invention.

### DESCRIPTION OF A PREFERRED EMBODIMENT

In FIG. 1, there is shown a schematic diagram of a system in accordance with an embodiment of the present invention, comprising 4 CPUs. The system software contains a number of different transaction types. For each CPU, there is a corresponding application process—namely H0, AH1, AH2, and AH3. An application process is a software module arranged to receive transaction requests from an application gateway process, act as an interface between the transaction request and the CPU. One example of a system software application which incorporates a system architecture such as the one described above is EAE (Enterprise Application Environment).

EAE is a proprietary fourth generation programming environment developed by Unisys Corporation. EAE is generally utilised to build and implement transaction processing systems, including the business logic components of a transaction processing system, the user interfaces of a transaction processing system, and the database schema of a transaction processing system. It will be understood that whilst the present invention is described with reference to the EAE environment, the present invention may be applied in any other suitable computing system.

In the example given, EAE (in accordance with the prior art) will affinitize every application process to one available CPU for all 4 available CPUs. That is, an affinity exists between an application process and a CPU.

EAE also incorporates an application gateway process which is responsible for routing the transaction requests to the application processes for execution.

It will be understood that the system software, application processes, application gateway process, and any other software application or module necessary to effect an embodiment of the present invention may be executed on any appropriate computing hardware.

In an embodiment of the present invention, the application gateway process contains a function “determineTransactionType” that receives the transaction request and determines the transaction type by analysing the request. The application gateway process, in one embodiment also contains second function “mapTransactionTypeToHost” which takes the transaction type and determines to which application host a transaction of this type should be routed. The algorithm mapping of the transaction type to a particular application host process preferably associates each transaction type with a separate CPU. Where there are more transaction types than CPUs (as in a later example), the application gateway process uses its knowledge about the transaction type to minimize the cache contention. If possible, the application gateway process allocates more CPU-intensive transactions more exclusive use of the CPU.

CPUs

The steps in processing a transaction, labelled in FIG. 1, are as follows:

Step 1. A transaction request enters the application gateway 1g.

Step 2. The application gateway 1g calls the “determineTransactionType” 1g function to determine the transaction type.

Step 3. The application gateway 1g calls the “mapTransactionTypeToHost” function to determine the most suitable application host, based on the information gathered with regard to the transaction type. The function map transaction type to host contains the algorithm that affinitizes transaction types to CPUs. There are a number of possible ways to construct an algorithm that affinitizes transaction types to CPUs. For example, a “static” affinitiziation methodology may be employed. In the static methodology, a transaction type is allocated to a particular CPU, and all transactions of the transaction type that enter the application gateway process will be directed to the allocated CPU. In other words, if, for example, a transaction type called “new-order” is affinitzed to CPU No. 1, then all requests to perform the new-order transaction which enter the application gateway process will be routed to CPU No. 1, irrespective of any other system conditions. For an algorithm to satisfy the requirements of an embodiment of this invention, the algorithm uses information with regard to the transaction type to choose which transactions to send to which CPUs, based upon the transaction type, so as to minimize cache contention and thereby preferably improve performance.

Step 4. The application gateway forwards the transaction to the appropriate host process for processing.

Step 5. The application host process executes the transaction on the CPU to which the host process is affinitized and returns the results to the application gateway.

Step 6. The application gateway returns the results of the transaction to the user 1u.

The affinization of transaction types to CPUs is best described by reference to various examples.

A first example of an embodiment of the present invention is illustrated in FIG. 2, where there is provided a transaction processing system that can perform 8 different types of transactions labelled 21a, . . . , 21h. The computing system that executes the transaction processing system is comprised of 8 CPUs labelled 22a, . . . , 22h. A simple method to ensure that the machine instructions of one transaction do not overwrite the machine instructions of another transaction in the CPU cache is to assign each transaction type to a particular CPU (assignation denoted by arrows 23). Thus if we label the CPUs as CPU1, CPU2, . . . , CPU8 and the transaction types as T1, T2, . . . , T8, in the present embodiment, T1 will always ran on CPU1, T2 on CPU2, and so on respectively for each of the 8 transaction types and CPUs.

In a second example as shown in FIG. 3, there is shown a scenario in which there are more available CPUs than transaction types. There are 8 available CPUs labelled 32a, . . . ; 32h but only 6 different transaction types 31a, . . . , 31f. If the aforementioned methodology was employed in this scenario (i.e. affinitizing each transaction type to one CPU), 2 CPUs would remain idle. Therefore, in order to avoid CPU resource wastage, the additional 2 CPUs have the most CPU intensive transaction types affinitized to them. Thus the most CPU intensive transaction types are affinitized to more than one CPU.

If transaction types T3 and T6 are executed very frequently and are allocated a large proportion of CPU resources compared to the other transaction types, the transaction type T3 could be assigned to CPU3 and CPU4 (via connector 34), and transaction type T6 could be assigned to CPU7(32g) and CPU8(32h). The relative “intensity” of a transaction type may be determined in any suitable way. “Intensity” may be measured by any suitable method or means. For example, the average amount of time required to process a transaction type may be kept in a table of values, and the affinitization of a transaction type to a CPU may be based on the statistical values kept in the table. In other words, historical data with regard to the average time taken to process a transaction of a particular type may be employed to determine whether a transaction is classified as “more intensive” or “less intensive”. Any suitable methodology may be employed to differentiate transactions of different intensities.

A third example of an embodiment of the present invention is as shown in FIG. 4, which describes a situation where there are more transaction types than CPUs (which is commonly the case in many real world transaction processing systems). If there are 4 available CPUs (labelled 42a, . . . , 42d) but 10 transaction types (labelled 41a, . . . , 41j) each CPU is assigned to at least one or more transaction types. The most CPU intensive transaction types would be allocated to at least one CPU exclusively, while the less CPU intensive transaction types may share a CPU. Thus if transaction type T4 is the most frequently executed transaction type and/or is the most CPU intensive transaction type, this transaction type T4 would be assigned to a single exclusive CPU (44).

Similarly, if transaction types T5 and T6 are found to be moderately CPU intensive, these transaction types would be assigned to another CPU (45). The remaining 7 transaction types, which are not CPU intensive and are not executed frequently may be assigned to the remaining two CPUs (43 and 46).

Each of the preceding examples illustrate the principle underlying an embodiment of the invention. Each transaction type should be affinitized to a CPU in such a manner as to minimize the overwriting of the machine instructions of one transaction type with the machine instructions of another transaction type. In order to achieve an embodiment of this invention, affinitization preferably requires a system or method for load management or load balancing, since different transaction types impose different loads on a CPU. Even in the first example give above, each transaction type has different CPU resource requirements. Whilst there are exactly the same number of transaction types as available CPUs, some more intensive transaction types may require exclusive access to more than one CPU, while other less CPU intensive transaction types can share a CPU.

It will be understood that while the above examples illustrate a way in which the load could be managed or balanced, the means of managing or balancing the load on the CPUs based upon the relative cost of the transaction types may be achieved by any suitable method. In an Enterprise Application Environment (EAE) a proprietary software development environment developed by Unisys, the affinitization of a transaction type to a CPU can be achieved indirectly by means of the application gateway and host processes. EAE provides an application host process for each available CPU in the computing system which can affinitize each of the host processes to a CPU. Thus, a transaction type may be indirectly affinitized to a CPU by sending transactions of a given type to the appropriate host process. Therefore, the affinitization process may be achieved in EAE by the use of the application gateway, in accordance with the following sequence of events:

1. A transaction request enters the application gateway.

2. The application gateway determines the transaction type.

3. The application gateway determines the most appropriate application host process, based upon the transaction type (and upon a load management mechanism not described in this patent application).

4. The application gateway forwards the transaction to the appropriate host process for processing.

5. The application host process executes the transaction on the CPU to which the host process is affinitized and returns the results to the application gateway.

6. The application gateway returns the results of the transaction to the user.

Thus, in EAE, transaction types are affinitized to CPUs indirectly by means of the host processes, that are themselves, in turn, affinitized to the CPUs. That is, each transaction type would be affinitized to one or more host processes, and each host process will be affinitized to its own CPU.

Modifications and variations as would be apparent to a skilled addressee are deemed to be within the scope of the present invention.

1. A method for processing a transaction in a transaction processing system, comprising the steps of, for a plurality of transaction types, associating each one of the plurality of transaction types with at least one of a plurality of central processing units, and, on receipt of a transaction request from a client, determining the transaction request type, locating the associated central processing unit, and forwarding the transaction request to the associated central processing unit.

2. A method in accordance with claim 1, comprising the further step of measuring the resource usage of a particular transaction type and utilising the resource usage data to allocate the transaction type to a central processing unit.

3. A method in accordance with claim 2, wherein the resource usage data includes data indicative of the number of transactions of a particular type are processed relative to other transaction types.

4. A method in accordance with claim 3, wherein the resource usage data includes data indicative of the amount of computing resources required to process a transaction.

5. A method in accordance with claim 4, wherein at least one less intensive transaction type shares processing time on a CPU with at least one another less intensive transaction type.

6. A system for processing transactions in a transaction processing system, comprising, association means arranged to associate each one of a plurality of transaction types with at least one central processing unit, and allocation means arranged, on receipt of a transaction request from a client, to determine the transaction request type, locate the associated central processing unit, and forward the transaction request to the associated central processing unit.

7. A system in accordance with claim 6, further comprising means to obtain resource usage date of at least one transaction type, wherein the resource usage data is employed by the allocation means to allocate the transaction type to a central processing unit.

8. A system in accordance with claim 7, wherein the resource usage data includes data indicative of the number of transactions of a particular type which are processed relative to other transaction types.

9. A system in accordance with claim 8, wherein the resource usage data includes data indicative of the amount of computing resources required to process a transaction type.

10. A method for affinitizing a transaction type to a central processing unit, the method comprising the steps of, for each transaction type, providing resource usage data indicative of the amount of computing resources required to process a transaction type, and using the resource usage data to associate each transaction type to at least one central processing unit.

11. A computer program arranged, when loaded on a computing system, to implement the method of any one of claims 1 to 5.

12. A computer readable medium providing a computer program in accordance with claim 11.
